(19) United States
(12) Patent Application Publication
(10) Pub. No.: US 2025/0092905 A1
(43) Pub. Date: Mar. 20, 2025

(54) CAGE NUT

(71) Applicant: AUDI AG, Ingolstadt (DE)

(72) Inventors: Michael ERNST, Wüstenrot (DE); Sophia MAY, llsfeld (DE); Uwe PALUMBO, Bad Friedrichshall (DE)

(73) Assignee: AUDI AG, Ingolstadt (DE)

(21) Appl. No.: 18/727,103

(22) PCT Filed: Jan. 12, 2023
(86) PCT No.: PCT/EP2023/050612

§ 371 Date: Jul. 8, 2024

(30) Foreign Application Priority Data
Feb. 21, 2022 (DE) 10 2022 104 013.5

(51) Int. Cl. F16B 37/14

(52) U.S. Cl. CPC F16B 37/14

(57) ABSTRACT

A cage nut for connection to a support element having a screw nut which is arranged in a captive and/or twist-proof manner in a nut cage which can be fastened to the support element and has play. The screw nut can be displaced between axial stops in the non-screwed state, and at least one spacer is formed on the screw nut front side facing toward an axial stop, via which the screw nut can be brought into contact with the axial stop, due to which an adhesive bond between the screw nut and the axial stop of the nut cage can be reduced. The spacer is produced in a forming process in which the screw nut is deformable to produce the spacer.

### FIELD

The invention relates to a cage nut and a method for producing such a cage nut.

### BACKGROUND

Cage nuts are used, among other things, for screwing tolerance-critical components to the body (for example for screwing on the seat, the door lock, or the battery housing, etc.). These are nuts having a wide variety of thread sizes, which in most cases consist of a square steel element into which the respective thread (or also only a hole for a self-tapping screw) is introduced. This steel element is then located in a so-called nut cage, in which it is embedded in both a captive and also twist-locked manner.

After the nut cage, including the screw nut located therein, has been welded into the body, a component can be screwed on later in the assembly with relatively large tolerances without the use of a counter-holder to absorb the torque during screwing. The screw nut is found by a screw having a threading tip, so that the screw nut is automatically centered in relation to the screw, which enables a reliable screw connection despite component tolerances.

With a conventional cage nut, the following problem arises in the vehicle manufacturing plant: The nut cage is welded in the body construction and therefore goes through the painting plant including cathodic dip painting together with the body. Depending on its position in the vehicle, the screw nut in the nut cage bonds more or less evenly to the body panel or the nut cage, due to the fact that the extremely thin cathodic dip painting paint spreads everywhere, including between the screw nut and the counter surface, does not run off there due to adhesive forces, and bakes between them in the subsequent hardening oven during drying. However, in order for the screw nut to be able to fulfill its actual function, it first has to be loosened again by applying force. Depending on the type of subsequent screw connection, this can (but does not have to) be done, for example, by an automated screwing device based on the pressure force on the screw when inserting the threading tip into the screw hole of the nut.

However, this does not function with manual screwing, so the worker first has to loosen the screw nut from its adhesive bond by applying a force, for example with a hammer blow.

Cage nut arrangements are known from DE 11 2017 008 057 T5, US 2004/0013492 A1, and JP 2014001839 A2.

### SUMMARY

The object of the invention is to provide a cage nut and a method for producing a cage nut in which, in comparison to the prior art, a reliable function of the cage nut can be ensured with a simple process

The invention relates to a cage nut for connection to a supporting element, in particular a body sheet metal part. The cage nut has a screw nut and a nut cage, which is fastenable fixed in place, in particular by a welded connection, on the supporting element. In the cage interior, the screw nut is arranged in a non-usage position with play in a captive and twist-locked manner, so that the screw nut can be moved by an axial distance between axial stops in one screwing direction. In a usage position, the screw nut is screwed together with a screw bolt, by means of which an attachment part can be clamped on the supporting element. In order to avoid an adhesive bond that occurs in the non-usage position (for example after completed cathodic dip painting process in vehicle manufacturing) between the screw nut and at least one axial stop of the nut cage, large contact surfaces between the screw nut and the cage axial stop are omitted. Instead, at least one spacer is formed on the screw nut front side facing toward the axial stop, which spacer protrudes from the screw nut front side. The screw nut front side can be brought into contact with the axial stop via the spacer. The spacer has a greatly reduced cross section in comparison to the screw nut front side, which also greatly reduces the adhesive bond resulting in the non-usage position between the screw nut and the cage axial stop (after the cathodic dip painting process). According to the characterizing part of claim 1, the spacer on the screw nut is produced in a forming process. In the forming process, the screw nut is deformed to create the spacer. It is preferred if, during the forming process, the forming force acts outside the screw nut front side on a circumferential screw nut edge side. In this way, the screw nut front sides remain free of mechanical engagements during the forming process. In addition, it is preferred if at least one spacer is formed on each of the screw nut front sides.

According to the invention, by introducing transverse embossings on the outer edge of the screw nut during the production thereof, very small, sharp burrs can be produced by material displacement on the support surface, on which the screw nut rests within the nut cage. The cathodic dip paint between the screw nut and the nut cage can therefore run off after the dipping process so that the two surfaces do not adhesively bond to one another.

In a simple technical implementation, the forming process can be an embossing process in which at least one embossing is introduced into the screw nut. The embossing is preferably positioned at least in the vicinity of the screw nut front side. This causes a material flow during the embossing process, due to which the screw nut front side bulges by a profile height, forming the spacer.

According to a first embodiment variant, the embossing may not be formed directly in the screw nut front side, but rather may be formed with an axial offset to the screw nut front side in the screw nut edge side. The screw nut can have a polygonal profile with profile edges extending between the screw nut front sides. The profile edges converge with outer edges at screw nut outer corners. At the outer edges, the respective screw nut front side merges into the screw nut edge side. With regard to a technically simple embossing process, it is preferred if the embossing on at least one profile edge is formed in such a way that the embossing interrupts the edge course of the profile edge. It has been shown that when forming the embossing on the profile edge, a reduced forming force is sufficient, in comparison to forming the embossing on a flat edge side. Alternatively, the embossing can also be positioned outside the profile edges, i.e., arranged in the circumferential direction at a distance from the profile edges.

In a further embodiment, the embossing process can be carried out directly on the outer corner of the screw nut, where an axially extending screw nut profile edge converges with screw nut outer edges extending transversely thereto. In this case, the embossing is formed directly on the screw nut outer corner.

In a further embodiment variant, the embossing can be positioned in the screw nut edge side in such a way that the adjacent outer edge course of the screw nut no longer extends linearly, but rather is curved to form the spacer. In this case, the outer edge course is not interrupted by the embossing. Alternatively, the embossing can also be formed directly on the outer edge so that the outer edge course is interrupted by the embossing. From a manufacturing point of view, it is simple if the embossing extends, for example, continuously in the form of a groove between the two axial screw nut front sides. In this way, the spacers on both screw nut front sides are produced simultaneously by exactly one embossing tool and in a single embossing process.

### BRIEF DESCRIPTION OF THE FIGURES

Exemplary embodiments of the invention are described in the following on the basis of the appended figures.

In the figures:

FIG. 1 shows the cage nut in a non-usage position;

FIG. 2 shows the cage nut in a usage position;

FIG. 3 shows a view of the cage nut in an exemplary embodiment;

FIG. 4 shows a view of the cage nut in an exemplary embodiment;

FIG. 5 shows a view of the cage nut in an exemplary embodiment;

FIG. 6 shows a view of the cage nut in an exemplary embodiment; and

FIG. 7 shows a view of the cage nut in an exemplary embodiment.

### DETAILED DESCRIPTION

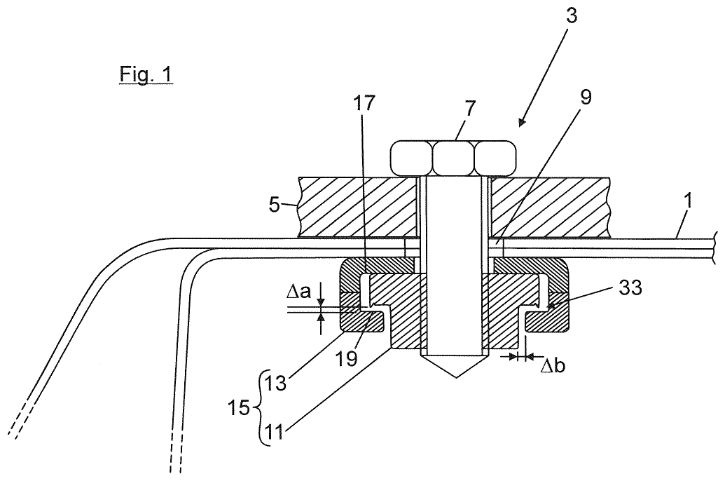

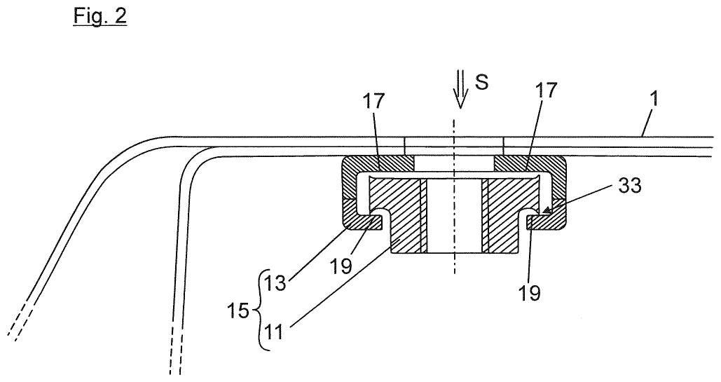

In FIG. 1, a body sheet metal part 1 of a vehicle body has a screw point 3. On the upper side of the body sheet metal part 1, an attachment part 5, for example a vehicle rear seat, is screwed via a screw bolt 7 to the screw point 3. In FIG. 1, the screw bolt 7 is guided through a screw hole 9 of the body sheet metal part 1 and is in threaded engagement with a screw nut 11 which is arranged on the side of the body sheet metal part 1 opposite to the attachment part 5. The screw nut 11, together with a nut cage 13, is part of a cage nut 15, which is shown in the screwed on state in FIG. 1. The nut cage 13 is welded to the body sheet metal part 1. In contrast, the cage nut 15 in FIG. 2 is shown in the non-screwed on state, in which the screw nut 11 is mounted floating with play in a cage interior of the nut cage 13.

According to FIGS. 1 and 2, the nut cage 13 has axial stops 17, 19, between which the screw nut 11 can be displaced by an axial path Δa in the screwing direction S (FIG. 2). In addition, the nut cage 15 has transverse stops, between which the screw nut 11 can be displaced over a transverse path transverse to the screwing direction S.

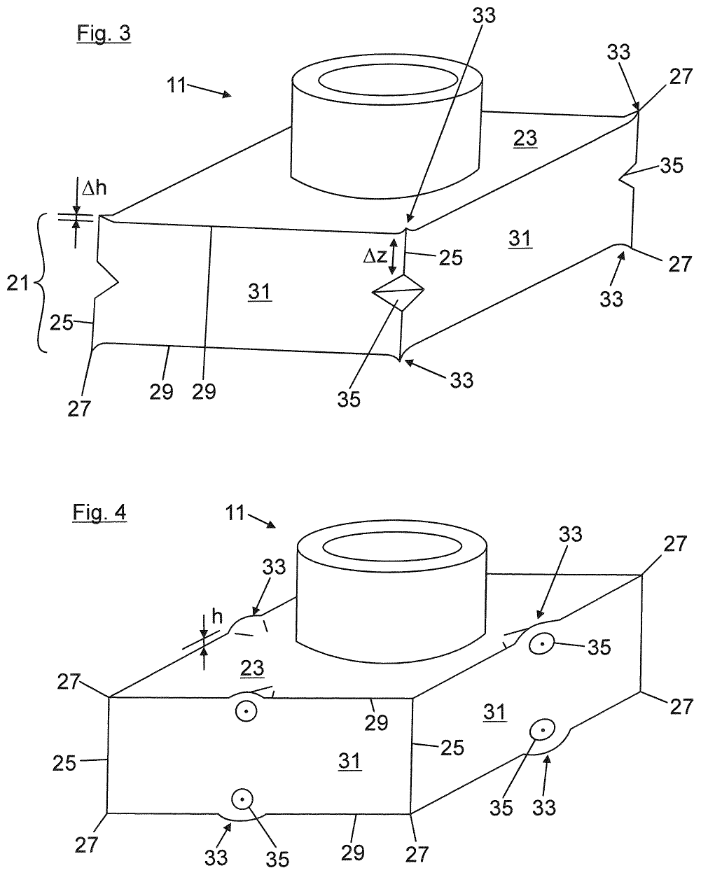

In FIG. 3, the screw nut 11 is designed having a cuboid base body 21, the axial front sides 23 of which can be brought into contact with the respective axial stops 17, 19 of the nut cage 15 facing toward them. The screw nut base body 21 has a square profile having a total of four profile edges 25. Each of the profile edges 25 converges at a screw nut outer corner 27 with outer edges 29, at which the respective screw nut front side 23 merges into a screw nut edge side 31.

In a manufacturing process in the body construction, the nut cage 15 having the screw nut 11 loosely mounted therein is welded to the body sheet metal part 1. The body sheet metal part 1 is then subjected to a cathodic dip painting process. After completion of the cathodic dip painting process, the attachment part 5 is screwed onto the screw point 3 of the body sheet part 1. In the case of a large-area contact between a screw nut front side 23 and an axial stop 17, 19 of the nut cage 15 facing toward it, there is a risk that the screw nut 11 will adhesively bond to the axial stop 17, 19 of the nut cage 15 facing toward it with the cathodic dip painting paint in between. Against this background, the screw nut 11 according to the invention has small-cross-sectional spacers 33 on each of its two axial front sides 23, via which the screw nut 11 can be brought into contact with the axial stops 17, 19 of the nut cage 15.

A core of the invention is that the spacers 33 are formed with simple manufacturing by an embossing process in the screw nut 11. During the embossing process, an embossing 35 is introduced into the screw nut 11 with the aid of an embossing tool. This causes a material flow, due to which the screw nut front side 23 bulges by a profile height h in the vicinity of the embossing 35, forming the spacer 33. By way of example, in FIG. 3, an embossing 35 is formed on each of the profile edges 25, which interrupts the edge course of the profile edge 25. The embossing 35 is formed with an axial offset Δz to the two screw nut front sides 23 in the screw nut profile edges 25. In this way, axially raised spacers 33 result directly at the outer corners 27 of the screw nut 11, which protrude from the respective screw nut front sides 23 by a profile height h.

Alternatively, in FIG. 4, the embossings 35 are not formed directly in the profile edges 25, but rather with a slight axial offset to the outer edges 29 and on the flat screw nut edge sides 31. According to FIG. 3, the outer edge course is not interrupted by the embossing 35. Rather, the outer edge course curves upwards by the profile height h, forming the spacer 33.

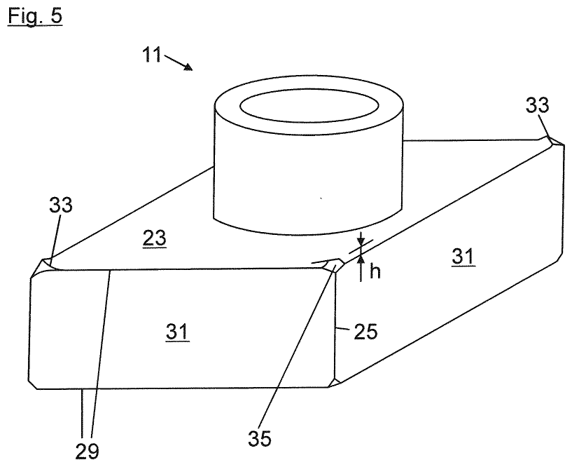

In FIG. 5, in order to form the spacers 33, the embossing tool is directed with a forming force directly onto the respective screw nut outer corner 27, due to which a spacer 33 builds up on the respective screw nut front side 23.

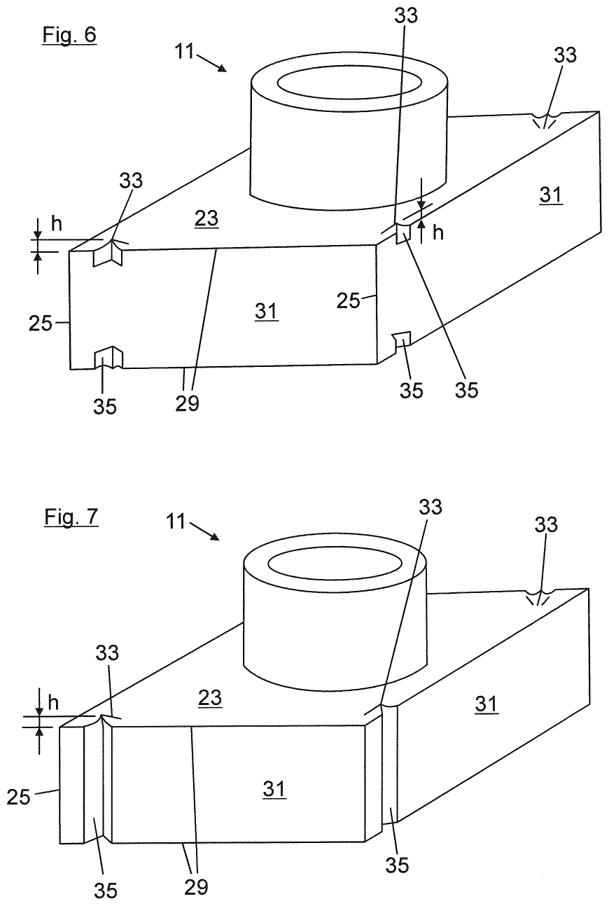

In FIG. 6, the embossings 35 are formed directly on the screw nut outer edges 29, due to which the outer edge course is interrupted by the embossings 35. According to FIG. 6, embossings 35 are introduced independently of one another on each of the axially opposite outer edges 29 of the screw nut base body 20. In contrast, in FIG. 7, the respective embossing 35 extends in the form of a groove and continuously between the two axial screw nut front sides 23. In this way, a spacer 33 is produced on each of the two axial screw nut front sides 23 using an embossing tool and an embossing process.

### LIST OF REFERENCE NUMERALS

1 supporting element
3 screw point
5 attachment part
7 threaded bolt
9 screw hole
11 screw nut
13 nut cage
15 cage nut
17,19 axial stops
21 screw nut base body
23 screw nut front sides
25 profile edges
27 screw nut outside corners
29 screw nut outer edges
31 screw nut edge sides
33 spacer
35 embossing
h profile height
S screw direction
Δa axial path
Δb transverse path
Δz axial distance

1-10. (canceled)

11. A cage nut for connection to a support element, in particular a body sheet metal part, comprising: a screw nut which is arranged in a captive and/or twist-proof manner in a nut cage which can be fastened to the support element and has play, wherein the screw nut can be displaced between axial stops in the non-screwed state, and wherein at least one spacer is formed on the screw nut front side facing toward an axial stop, via which the screw nut can be brought into contact with the axial stop, due to which in particular an adhesive bond between the screw nut and the axial stop of the nut cage can be reduced,
wherein the spacer is produced in a forming process in which the screw nut is deformable to produce the spacer.

12. The cage nut according to claim 11, wherein the forming process takes place outside the screw nut front side on a circumferential edge side of the screw nut.

13. The cage nut according to claim 11, wherein the forming process is an embossing process in which at least one embossing can be introduced into the screw nut, which causes a material flow, due to which the screw nut front side bulges to form the spacer in the vicinity of the embossing, and/or the spacer forms as a material burr.

14. The cage nut according to claim 13, wherein the embossing is formed in the screw nut edge side, specifically with an axial offset to the screw nut front side.

15. The cage nut according to claim 11, wherein the screw nut has a polygonal profile having profile edges extending between the screw nut front sides, and in that in particular the embossing is formed on at least one profile edge, so that the embossing interrupts the edge course of the profile edge.

16. The cage nut according to claim 15, wherein the embossing is positioned in the circumferential direction at a distance from the profile edges in the screw nut edge side.

17. The cage nut according to claim 15, the embossing is formed on at least one outer corner of the screw nut at which the profile edge terminates at the front side.

18. The cage nut according to claim 12, wherein the axial screw nut front side and the screw nut edge side converge at outer edges, and in that in particular the outer edge profile is curved to form the spacer.

19. The cage nut according to claim 18, wherein the embossing is formed on the outer edge so that the outer edge course is interrupted by the embossing, and in that in particular the embossing extends continuously between the two axial screw nut front sides.

20. A method for production of a cage nut according to claim 11, wherein the spacer is produced in a forming process in which the screw nut is deformed to produce the spacer.

21. The cage nut according to claim 12, wherein the forming process is an embossing process in which at least one embossing can be introduced into the screw nut, which causes a material flow, due to which the screw nut front side bulges to form the spacer in the vicinity of the embossing, and/or the spacer forms as a material burr.

22. The cage nut according to claim 12, wherein the screw nut has a polygonal profile having profile edges extending between the screw nut front sides, and in that in particular the embossing is formed on at least one profile edge, so that the embossing interrupts the edge course of the profile edge.

23. The cage nut according to claim 13, wherein the screw nut has a polygonal profile having profile edges extending between the screw nut front sides, and in that in particular the embossing is formed on at least one profile edge, so that the embossing interrupts the edge course of the profile edge.

24. The cage nut according to claim 14, wherein the screw nut has a polygonal profile having profile edges extending between the screw nut front sides, and in that in particular the embossing is formed on at least one profile edge, so that the embossing interrupts the edge course of the profile edge.

25. The cage nut according to claim 13, wherein the axial screw nut front side and the screw nut edge side converge at outer edges, and in that in particular the outer edge profile is curved to form the spacer.

26. The cage nut according to claim 14, wherein the axial screw nut front side and the screw nut edge side converge at outer edges, and in that in particular the outer edge profile is curved to form the spacer.

27. The cage nut according to claim 15, wherein the axial screw nut front side and the screw nut edge side converge at outer edges, and in that in particular the outer edge profile is curved to form the spacer.

28. The cage nut according to claim 16, wherein the axial screw nut front side and the screw nut edge side converge at outer edges, and in that in particular the outer edge profile is curved to form the spacer.

29. The cage nut according to claim 17, wherein the axial screw nut front side and the screw nut edge side converge at outer edges, and in that in particular the outer edge profile is curved to form the spacer.
